(19) United States
(12) Patent Application Publication
(10) Pub. No.: US 2010/0047489 A1
(43) Pub. Date: Feb. 25, 2010

(54) Super beam

(75) Inventor: Anthony John Cesternino, Callaway, VA (US)

Correspondence Address: Anthony J. Cesternino, 597 Five Mile Mt. Road, Callaway, VA, 24067, US

(73) Assignee: SUPER BEAM

(21) Appl. No.: 12/229,231

(22) Filed: Aug. 21, 2008

(51) Int. Cl. B32B 1/08

(52) U.S. Cl. 428/34.1

(57) ABSTRACT

The Super Beam is comprised of any structural medium hollowed out to receive any or all of a carbon composite core.

Using the structural medium for the purpose of attachment to adjacent structures.

This allows the carbon composite core which is the primary strength of the Super Beam not to be altered by any holes [drilled, nailed or screwed, etc.] or heat transfer by welding.

After all engineered requirements for adjacent attachments are made to the hollowed structural medium the carbon composite core can be inserted into the hollowed structured medium.

This now allows the Super Beam to be attached to adjacent structures without compromising the rated strength of the carbon composite core.

### RELATED U.S. DOCUMENTS

NONE

### REFERENCES CITED

NONE

### TECHNICAL FIELD

This invention relates to load bearing beams particularly where greater strength or overall weights are factors

### BACKGROUND

a] This invention relates to semi-trailers with a need to be stronger and lighter.

b] This invention relates to any infrastructure or commercial construction new or old needing the reinforcement to carry loads

### SUMMARY OF THE INVENTION

Accordingly this invention is directed to improve attachment of beams to any adjacent structural medium without losing the rated strength of the carbon composite core

### BRIEF DESCRIPTION OF THE DRAWINGS

FIG. 1A is a three dimensional view of a Double I-H beam with carbon composite core.

FIG. 1B is a three dimensional view of a semi-trailer constructed of Double I-H beams with carbon composite cores.

FIG. 2A is a three dimensional view of a Double I-H beam with a carbon composite core

FIG. 2B is a three dimensional view of a triangular tube with a carbon composite core.

FIG. 2C is a three dimensional view of a carbon composite core with caps and collar.

### DETAILED DESCRIPTION

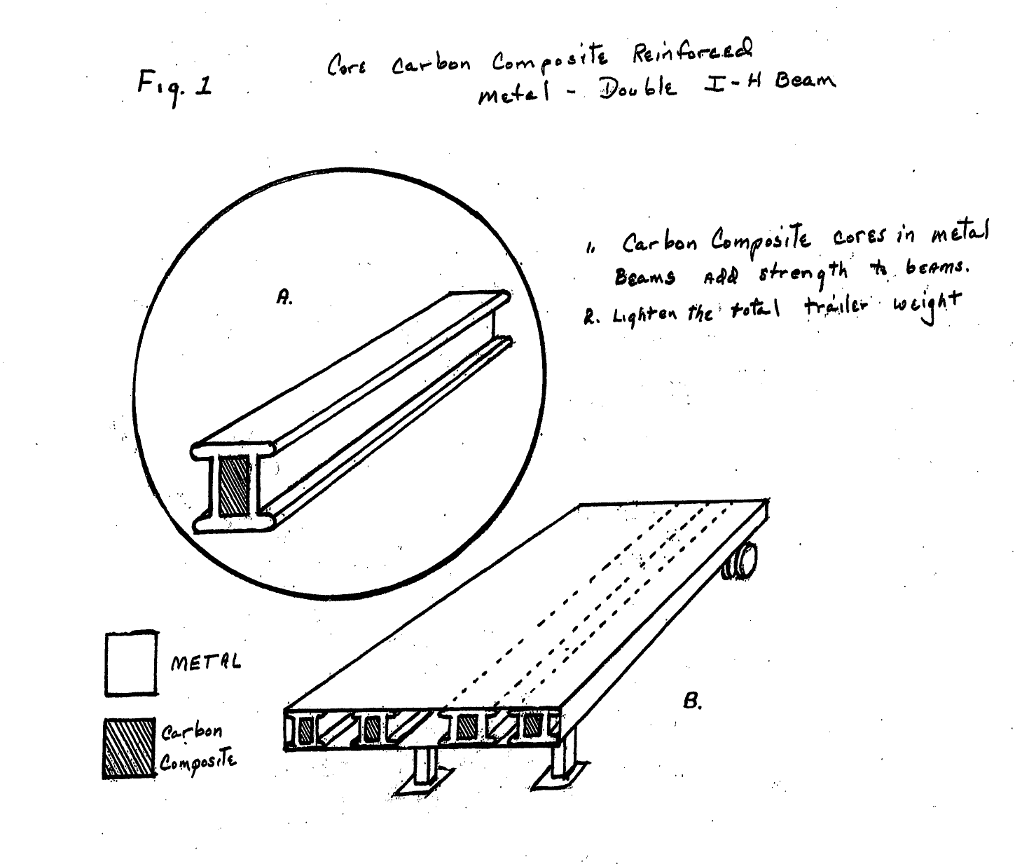

Referring to FIG. 1A, showing the relationship of a Double I-H beam with its carbon composite core insert.

Referring to FIG. 1B, shows the relationship of a Double I-H beam with carbon composite core supporting the deck of a semi-trailer.

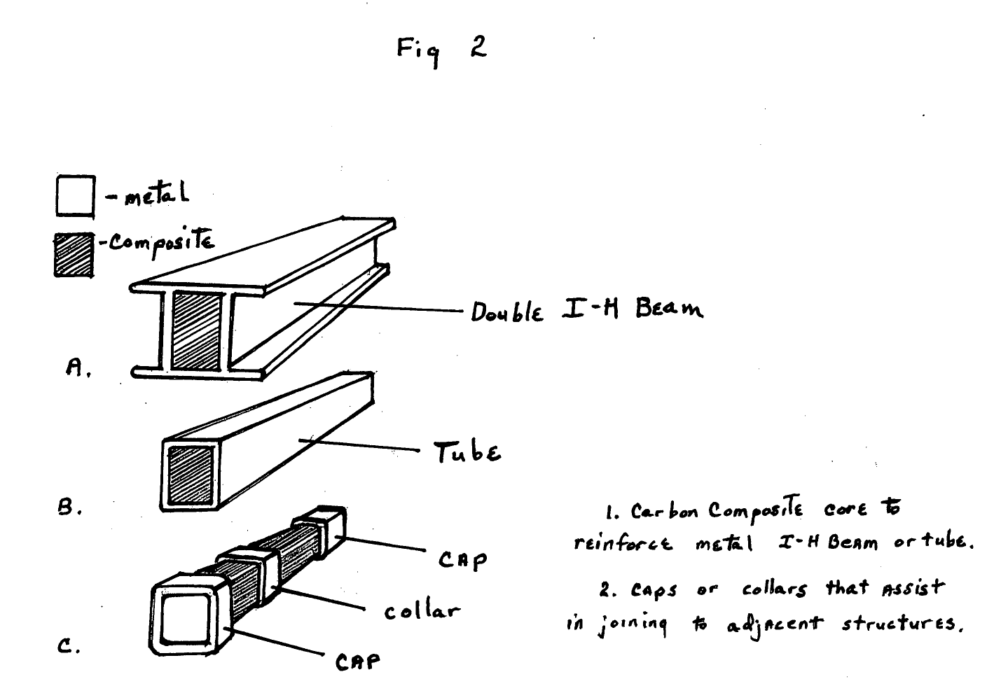

Referring to FIG. 2A, shows the relationship of a Double I-H beam with its carbon composite core.

Referring to FIG. 2B, shows the relationship of a rectangular tube with a carbon composite core.

Referring to FIG. 2C, shows the relationship of a carbon composite core with collar and end caps.

What is claimed is:

1. When a carbon composite core is inserted into a hollowed structural medium, comprising of a double I-H beam, tube, pipe, collar, caps, the carbon composite core being the primary source of strength, now allows the hollowed structural medium to accept any alterations needed for attachment to adjacent structures without compromising the rated strength of the carbon composite core.
